(19) United States
(12) Patent Application Publication
(10) Pub. No.: US 2026/0191621 A1
(43) Pub. Date: Jul. 9, 2026

(54) ARRANGEMENT APPLIED TO A DENTAL SHANK

(71) Applicants: Simone Melara MANSSUR, Porto Alegre (BR); Rafael MELARA, Porto Alegre (BR)

(72) Inventors: Simone Melara MANSSUR, Porto Alegre (BR); Rafael MELARA, Porto Alegre (BR)

(21) Appl. No.: 19/130,691

(22) PCT Filed: Jan. 5, 2023
(86) PCT No.: PCT/BR2023/050002

§ 371 Date: May 16, 2025

(30) Foreign Application Priority Data
Nov. 18, 2022 (BR) 2020220235258

(51) Int. Cl. A61C 3/06

(52) U.S. Cl. CPC A61C 3/06

(57) ABSTRACT

The dental rod arrangement for diamond tip of the utility model comprises a cylindrical body (1) with tip (11) in a conical trunk shape having a rounded end containing a surface (111) composed of smooth areas interspersed with high (111-A) and low (111-B) reliefs, with different depths forming contact bands. Said areas of high (111-A) and low (112-A) reliefs can, optionally, be impregnated with diamonds of different grain sizes, thus allowing the professional to have greater wear control of the surface of dental restorations when performing the texturing procedure.

### TECHNICAL SECTOR

The present utility model belongs to the technical sector of tools for dentistry and refers more specifically to a new constructive arrangement introduced into a dental rod for dental diamond tip.

### STATE OF THE ART

For the texturing activity of dental restorations, multilaminate drills are known rotating instruments made of varied materials with blades angled to each other that allow the removal of excess resin in restorations. These drills perform a uniform wear of the surface of composite resin restorations, not producing a texture pattern close to natural teeth.

A known solution is dental rods containing diamond on their surface (diamond tips) for texturizing restorations. Said rods commonly employ particles of materials with high hardness to assist in the wear of the surface of the restorations. However, even so, these rods do not leave the patient's tooth with a texture pattern similar to its original design, leaving it with irregular lines and making the surface of the restored teeth different to each other.

The patent document JP2126843 describes a rod with a fine, pointed tip and a diamond film on the surface, making it possible to cut or polish resins. A drawback of this tip is irregularly dispersed diamond grains, making it impossible to regularly texturize the tooth, leaving it with a surface different to the natural one.

The patent document JP6022982 describes a rod with a cylindrical tip with abrasive diamond grains. This tip has the same drawback as the previous patent, with diamond grains arranged in an irregular way, not producing homogeneous and controlled surface wear in the restoration, and has a cylindrical shape, which makes it difficult to finish and texturize hard-to-reach faces.

### NOVELTY AND OBJECTIVE OF THE PROPOSED MODEL

The new construction arrangement introduced into a dental rod for the performance of dental texturizing procedures, proposed by the present utility model, effectively resolves the limitations of the prior art previously mentioned.

The dental rod of the present model has an end with interspersed areas of different depths, presenting alternation between peaks and troughs, allowing greater control by the dental professional in the texturing of restorations, enabling a controlled and standardized wear of the restoration surface, when this rod has diamond grains on its surface.

Optionally, said rod can contain diamond grains throughout the end with interspersed areas to aid in texturing restorations.

### FUNCTIONAL IMPROVEMENT OF THE PROPOSED MODEL

The new constructive arrangement introduced into a dental rod, proposed by the present utility model, results in the following functional improvement:
State-of-the-art dental rods have ends with diamonds randomly arranged over the entire surface, making it impossible to perform controlled and interspersed wear for the texturing of restorations. Solved by the present model through an end with interspersed areas of high and low relief that allow a greater control of wear bands by the professional, where the high relief areas will first touch the tooth surface, producing a wear pattern in bands;
It allows the reproduction of the same texture pattern in more than one resin restoration in the same patient, and can also be used for texturing porcelain restorations, both by the dental surgeon and by the dental technician; and
It maintains a natural distance between the grooves produced on the surface of the resin restoration.

### LIST OF ACCOMPANYING DRAWINGS

In order for this model to be fully understood and put into practice by any person skilled in the art, it is now described in a clear, precise and sufficient manner, based on the accompanying drawings, listed below, which illustrate embodiments of the dental rod:

FIG. 1—perspective view of the dental rod;

FIG. 2—perspective view of the tip of the dental rod; and

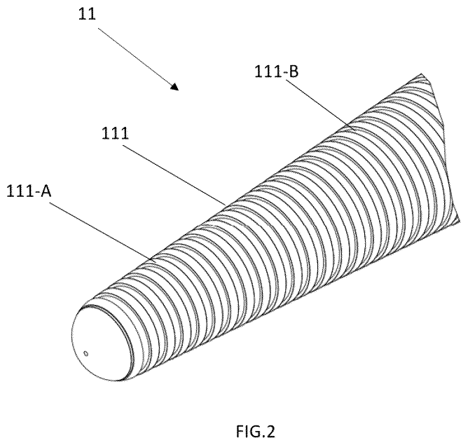

FIG. 3—perspective view of the dental rod with the entire diamond tip.

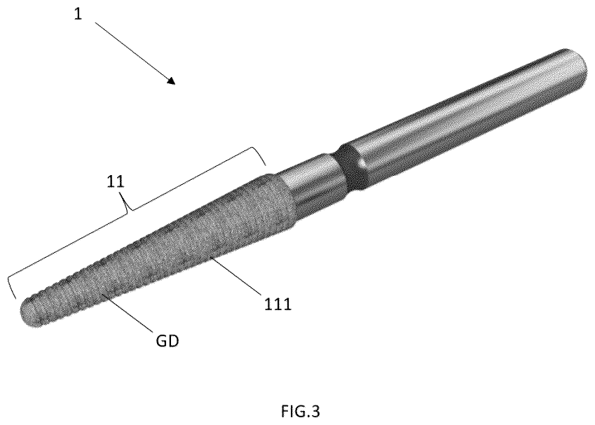

### DESCRIPTION OF THE MODEL

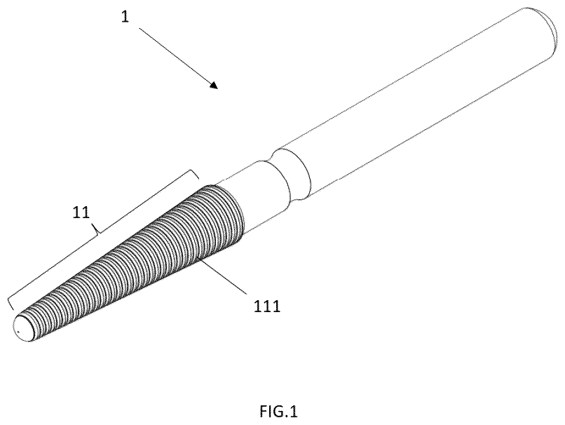

FIG. 1 illustrates the new constructive arrangement introduced into a dental rod, which comprises a cylindrical body (1) with a tip (11) in a conical trunk shape with a rounded end containing a surface (111) composed of smooth areas interspersed with high (111-A) and low (111-B) reliefs, with different depths forming contact bands. Said areas of high (111-A) and low (112-A) reliefs allow the professional to have greater wear control of the surface of dental restorations in the texturing process, when a diamond grain (GD) coating is applied to this tip.

Optionally, the tip (11) can have a varied taper or be cylindrical in shape, with the most varied lengths, according to the professional's preference.

The interspersed wear areas of high (111-A) and low (111-B) reliefs can have different widths and depths to perform interleaved wear also with different widths and depths.

Preferably, said rod is made of stainless-steel material, but not limited to this.

The tip (11) contains a preferentially frustoconical shape, but is not limited to this.

The dental rod is fixed through a Friction Grip or Push Button system or similar, to a dental motor or similar equipment, which makes it possible to rotate it so that it can texture the dental restoration (high-speed turbine, low-speed counter-angle, low-speed counter-multiplier angle or angle counter adapted to electric motors).

The resin dental restoration is a treatment used to restore cavities affected by caries, defective restorations, dental fractures, etc.

Anterior and posterior tooth restorations must restore function and aesthetics, reproducing the anatomy, color, and texture in a natural way, similar to natural teeth. When performing restorations on anterior teeth, an important aspect to be carried out in the finishing stage of restorations is to texturize the surface of the resin in order to simulate the striations present in natural teeth, which usually appear as horizontal lines of high and low relief arranged on the surface of the teeth. Through the use of the diamond tip of this invention, the texturing of the resin restoration makes this surface very close to the pattern found in natural teeth.

Alternatively, said rod can receive diamond grains (GD) over its entire surface (111) to assist in the texturing of the restorations. Said diamond grains (GD) can present different sizes to perform wear at different depths.

1. ARRANGEMENT APPLIED TO A DENTAL SHANK consisting of at least one cylindrical body (1) with a tip (11) that connects to a conventional dental rotating device, characterized in that the tip (11) contains a surface (111) composed of smooth areas interspersed with high (111-A) and low (111-B) reliefs, with different depths forming contact bands;

2. THE ARRANGEMENT INTRODUCED IN DENTAL ROD according to claim 1, characterized in that the tip (11) optionally has a conical or cylindrical trunk shape with a rounded end containing a surface (111) composed of wear areas interspersed with high (111-A) and low (111-B) reliefs.

3. THE ARRANGEMENT INTRODUCED INTO A DENTAL ROD according to claim 1, characterized in that the surface (111) optionally contains diamond grains (GD) in its interspersed areas, both in the high (111-A) and in the low (111-B) relief.
